(19) United States
(12) Patent Application Publication
(10) Pub. No.: US 2017/0222805 A1
(43) Pub. Date: Aug. 3, 2017

(54) Escrow key fragmentation system

(71) Applicant: Cocoon Data Holdings Pty Limited, Sydney (AU)

(72) Inventors: Trent David Telford, Alpine (AU); William Stroud, McLean, VA (US); Robert Graham Bartlett, Greenwich (AU); Simon Wild, Clareville (AU)

(21) Appl. No.: 15/421,442

(22) Filed: Feb. 1, 2017

(30) Foreign Application Priority Data
Feb. 3, 2016 (AU) 2016900350

(51) Int. Cl. H04L 9/08; H04L 9/30; H04L 9/14

(52) U.S. Cl. CPC H04L 9/0894; H04L 9/0822; H04L 9/085; H04L 9/14; H04L 9/30

(57) ABSTRACT

A method of managing access to a key. The method comprises associating the key with an encrypted data object, the key being required to decrypt the data object; generating a number of fragments of the key, the number of fragments corresponding to a number of parties subject to a fragmentation agreement; and encrypting each fragment with a public key corresponding to each of the parties. The method further comprises encrypting each encrypted fragment with a public key of a trusted party; and storing the encrypted fragments with the encrypted data object on a server of the trusted party.

### REFERENCE TO RELATED PATENT APPLICATION(S)

This application claims the benefit under 35 U.S.C. §119 of the filing date of Australian Patent Application No. 2016900350, filed 3 Feb. 2016, hereby incorporated by reference in its entirety as if fully set forth herein.

### TECHNICAL FIELD

The present invention relates generally to data encryption and, in particular, to a system and method for escrow key fragmentation.

### BACKGROUND

Owners of data often encrypt data for security reasons. A government or legal entity (referred to as a “third party”) may request access to the data that has been encrypted by the owner. The owner may not want to allow the third party to have direct and free access to the key to access the encrypted data. However, subject to legal requirements, the owner may by agreement allow the release of the key. A method known as key fragmentation allows each of a number of parties to control part of the key (a key fragment). Only by bringing the parts together can the third party get the complete key and thereby access the encrypted data. As such, the legality of access by the third party can be essentially approved by other holders of key fragments.

A problem associated with key fragmentation is managing all the separate fragments of key data and then being able to reassemble the fragments to a complete key. Because such arrangements lead to fragmentation of information, data management can be difficult to implement. Further, the time between data being encrypted and then subsequently being requested by the third party may be in the region of several years, adding further difficulty to data management.

### SUMMARY

It is an object of the present invention to substantially overcome, or at least ameliorate, one or more disadvantages of existing arrangements.

According to a first aspect of the present disclosure there is provided a method of managing access to a key comprising: associating the key with an encrypted data object, the key being required to decrypt the data object; generating a number of fragments of the key, with the number of fragments corresponding to a number of parties subject to a fragmentation agreement; encrypting each fragment with a public key corresponding to each of the parties; encrypting each encrypted fragment with a public key of a trusted party; and storing the encrypted fragments with the encrypted data object on a server of the trusted party.

Other aspects are also disclosed.

### BRIEF DESCRIPTION OF THE DRAWINGS

A least one embodiment of the present invention will now be described with reference to the drawings and appendices, in which:

FIG. 1A shows a system for key fragmentation;

FIG. 1B forms a schematic block diagram of a general purpose computer system upon which arrangements described can be practiced;

FIG. 2 shows a method executed at an owner computing device; and

FIG. 3 shows operation of a system for re-assembling the fragmented key.

### DETAILED DESCRIPTION INCLUDING BEST MODE

Methods of data cryptography are generally known, including use of symmetric keys for encrypting and decrypting data. Australian Patent Publication No. 2013200771 described an example system for data cryptography using a secure server.

Under the presently described arrangements, a number of parties, such as a government agency, and an independent body, each hold a means of decrypting a fragment of the key required to decrypt an encrypted data object. If the government agency (third party) wants to access the data, the government agency needs all separate parties to hand over their fragment to form the complete key. As discussed above, this process can be difficult to manage given typical amounts of different data and time frames involved.

The arrangements described provide a system and method for holding the encrypted data and the key fragments in central repositories that can be easily managed and maintained while still complying with the requirements of key fragmentation. As a result of such arrangements, each party can securely maintain their respective fragments. The third party can only get access based on agreement of all parties involved.

### System Overview

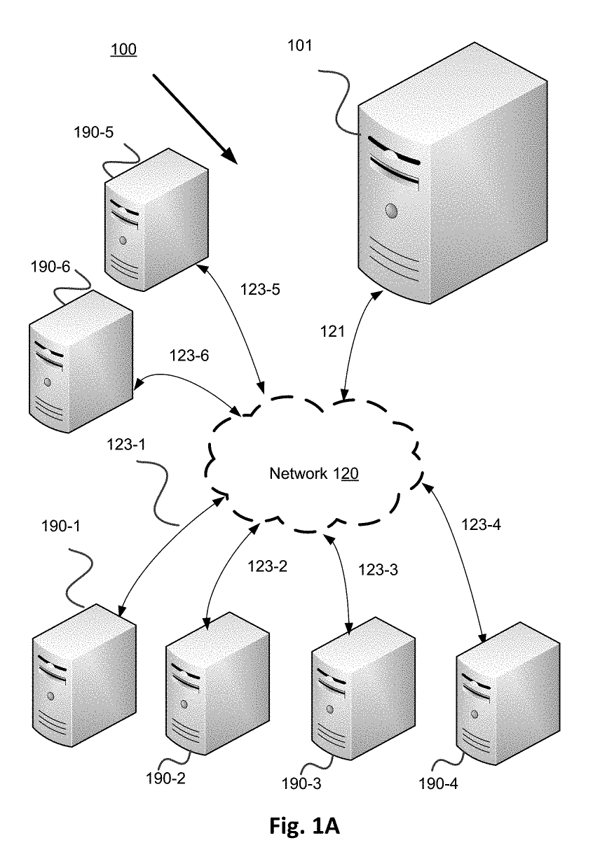

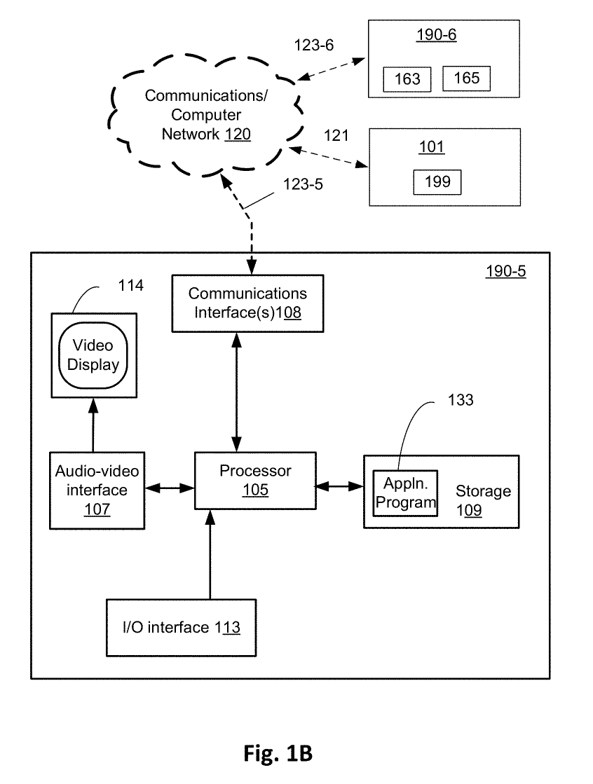

An owner of data operates an owner computing device 190-5. The owner uses a key to decrypt data, and wants to fragment the key to comply with regulatory requirements. In the arrangements described, parties involved in fragmentation of a key are referred to as “escrow parties”. At least two escrow parties must be involved in any key fragmentation agreement or arrangement. The example of FIG. 1A relates to four escrow parties. Each escrow party operates a computing device, as shown by computing devices 190-1, 190-2, 190-3 and 190-4, also referred to as escrow devices. The system 100 also includes a computing device 190-6 associated with an independent trusted party (t) of the key fragmentation system.

Each escrow party (i) has a corresponding asymmetric key pair comprising a public key Pubᵢ and a private key Privᵢ. Similarly, the trusted party (t) has an asymmetric key pair comprising a public key Pubₜ and a private key Privₜ. The owner (o) also has an asymmetric key pair comprising of a public key Pubₒ and a private key Privₒ.

Each of the escrow devices 190-1, 190-2, 190-3, 190-4, 190-5 and 190-6 may be coupled to a network 120 via connections 123-1, 123-2, 123-3, 123-4, 123-5 and 123-6 respectively. Similarly, a server computer 101 is coupled to the network 120 via a connection 121.

Communications between the computers 101, 190-1, 190-2, 190-3, 190-4, 190-5 and 190-6 and the network 120 are normally carried out using secure standards such as Transport Layer Security (TLS) or Secure Sockets Layer (SSL).

The network 120 may be any suitable type of wired or wireless network, or a combination of wired and/or wireless networks. The connections 121, 123-1, 123-2, 123-3, 123-4, 123-5 and 123-6 may each be wired or wireless connections or a combination of wired and wireless connections. For example, the connection 121 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like.

FIG. 1B shows a schematic block diagram of a general purpose computing device relating to the computing device 190-5, upon which the methods to be described are desirably practiced. The devices 101, 190-1, 190-2, 190-3, 190-4 and 190-6 operate in a similar manner to the device 190-5, also referred to as the computer 190-5.

As seen in FIG. 1B, the computer 190-5 comprises storage device or module 109. The computer 190-5 includes a processing unit (or processor) 105 which is bi-directionally coupled to the storage module 109. The storage module 109 may be formed from non-volatile semiconductor read only memory (ROM) and semiconductor random access memory (RAM). The RAM may be volatile, non-volatile or a combination of volatile and non-volatile memory.

The computer 190-5 includes an audio-video interface 107, which is connected to a video display 114, such as a liquid crystal display (LCD) panel or the like. The interface 107 is configured for displaying graphical images on the video display 114 in accordance with instructions received by execution of the processor 105.

The computer 190-5 also includes an I/O interface 113. The I/O interface 103 is connected to inputs (not shown) which a user of the computer 101 can manipulate, such as a keyboard, a mouse, a microphone and the like. The user inputs, the I/O interface 113 and the display 114 may operate with one another to form a graphical user interface (GUI) operable by the user of the computer 190-5. The I/O interface 113 may also be connected to outputs (not shown) such as a printer, speakers, and the like.

The computer 190-5 may also comprise a portable memory interface (not shown) to allows a complementary portable memory device to be coupled to the computer 190-5 to act as a source or destination of data or to supplement the storage module 109. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The computer 190-5 also has a communications interface 108 to permit coupling of the device 190-5 to another computer, a modem, or the communications network 120 via the connection 123-5.

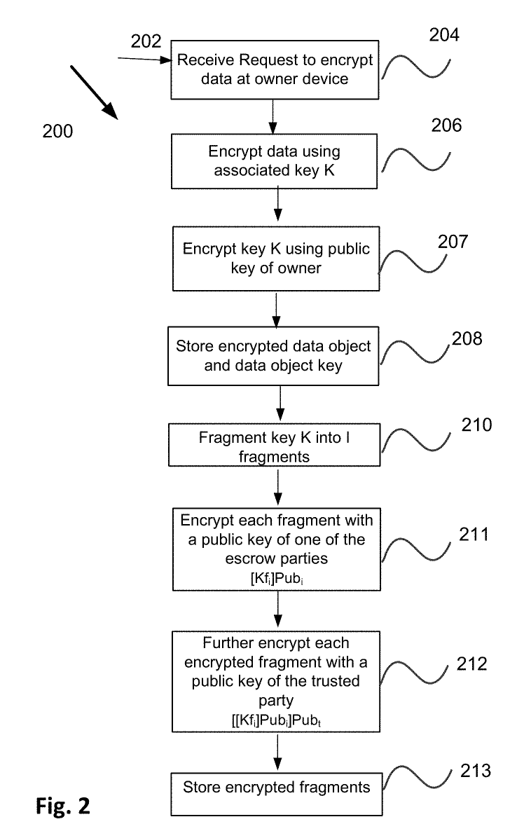

The methods described hereinafter may be implemented using the processor 105, where the processes of FIG. 2 may be implemented as one or more software application programs 133 executable on the processor 105. The computer 190-5 of FIG. 1B implements the described methods. In particular, with reference to FIG. 1B, the steps of the described methods are effected by instructions in the software 133 that are carried out by execution of the processor 105. The software instructions may be formed as one or more code modules, each for performing one or more particular tasks. The software 133 may also be divided into two separate parts, in which a first part and the corresponding code modules performs the described methods and a second part and the corresponding code modules manage a user interface between the first part and the user.

The software 133 is typically stored in the non-volatile ROM of the internal storage module 109. The software 133 stored in the ROM can be updated when required from a computer readable medium. The software 133 can be loaded into and executed by the processor 105. In some instances, the processor 105 may execute software instructions that are located in the RAM portion of the module 109. Software instructions may be loaded into the RAM by the processor 105 initiating a copy of one or more code modules from ROM into RAM. Alternatively, the software instructions of one or more code modules may be pre-installed in a non-volatile region of RAM by a manufacturer. After one or more code modules have been located in RAM, the processor 105 may execute software instructions of the one or more code modules.

The application program 133 may be pre-installed and stored in the ROM of the module 109 by a manufacturer, prior to distribution of the server computer 101. However, in some instances, the application programs 133 may be supplied to the user encoded on one or more CD-ROM (not shown) and read via the portable memory interface prior to storage in the internal storage module 109. In another alternative, the software application program 133 may be read by the processor 105 from the network 120, or loaded into the controller 102 or a portable storage medium from other computer readable media. Computer readable storage media refers to any non-transitory tangible storage medium that participates in providing instructions and/or data to the processor 105 for execution and/or processing. Examples of such storage media include floppy disks, magnetic tape, CD-ROM, a hard disk drive, a ROM or integrated circuit, USB memory, a magnetic-optical disk, flash memory, or a computer readable card such as a PCMCIA card and the like, whether or not such devices are internal or external of the device 190-5. Examples of transitory or non-tangible computer readable transmission media that may also participate in the provision of software, application programs, instructions and/or data to the device 101 include radio or infra-red transmission channels as well as a network connection to another computer or networked device, and the Internet or Intranets including e-mail transmissions and information recorded on Websites and the like. A computer readable medium having such software or computer program recorded on it is a computer program product.

Each step or sub-process in the processes of the methods described below is associated with one or more segments of the application program 133, and is performed by repeated execution of a fetch-execute cycle in the processor 105 or similar programmatic operation of other independent processor blocks in the computer 190-5.

Similarly to the computer 190-5, the device 190-6 includes a processor 165 (similar to the processor 105) and an application 163 (similar to the application 133) executable on the processor 165. The server computer 101 includes a memory 199 similar to the memory 109.

### System Operation

In a preferred arrangement to be described, the device 190-5 relates to the owner of a data object. The owner encrypts the data object to restrict access thereto using known cryptographic methods, such as those described in Australian Patent Application No. 2013200771. The owner wants to fragment a key required such that resultant key fragments require permission of associated escrow parties to be reassembled. Such allows the owner some control over whether the third party acquires access to the key.

FIG. 2 shows a method 200 for encrypting data upon a device, and requesting fragmentation of an associated key. The method 200 is executed on the device 190-5, by execution of the application 133 on the processor 105.

The method 200 begins at a step 204. At step 204, the device 190-5 receives instructions to encrypt a data object (d) by owner manipulation of inputs of the device 190-1. The owner inputs are indicated by an arrow 202.

The method 200 continues to a step 206. At step 206, the application 133 executes to encrypt the data object d to create an encrypted object (D) using a key K associated with the data object. The key K is associated with the data object D and required to decrypt the object D. The key K may be generated by the server computer 101, or by the device 190-5. Whether the key K is generated by the server computer 101, or by the device 190-5, is determined by the owner in relation to privacy laws in a jurisdiction in which the encryption occurs.

The method 200 continues to step 207. At the step 207 key K is encrypted with the owner's public key Pubₒ to give an encrypted key referred to as [K]Pubₒ.

The method 200 proceeds to step 208. The encrypted data object D and the encrypted key [K]Pubₒ are stored at step 208. The encrypted object D and [K]Pubₒ may be stored in the memory 109 of the device 190-5 at this stage. Additionally, the encrypted object D and the [K]Pubₒ are stored in the memory 199 of the server computer 101.

The method 200 continues to a step 210. At step 210 the device 190-5 fragments the key K amongst i escrow parties. The fragments of the key K generated in step 210 are referred to hereafter as Kfᵢ, where “i” relates to a corresponding one of the escrow parties.

The method 200 continues under execution of the processor 105 to a step 211. At step 211, each fragment of key K generated at step 210 is encrypted using a public key corresponding to one of the escrow parties. Each of the resultant encrypted key fragments is referred to as [Kfᵢ]Pubᵢ for each corresponding fragment/escrow device pair.

The method 200 continues under execution of the processor 105 to a step 212. At step 212, each encrypted key fragment [Kfᵢ]Pubᵢ is encrypted with the public key of the independent trusted party. The resultant encrypted fragments are referred to as [[Kfᵢ]Pubᵢ]Pubₜ.

The method 200 continues under execution of the processor 105 to a step 213. At step 213, all of the encrypted key fragments generated in step 212 are stored in the memory 199 of the server computer 101 by the owner device 190-5. Depending on the legal jurisdiction of where the key K was created, the encrypted fragments of key K may also be stored in a memory of a corresponding one of the escrow devices 190-1, 190-2, 190-3 and 190-4.

As the fragments and the encrypted data object are stored in a central repository, difficulties relating to tracking and finding the relevant fragments and data over time are obviated. As the fragments are each encrypted by different public keys, the key cannot be reassembled without permission from each escrow party, who must decrypt the corresponding encrypted fragment with the corresponding private key. Such maintains security of the data even though the fragments and data are stored in the same location.

The arrangements described include two levels of encryption of the key fragments—by the public keys of the relevant escrow party and then by the public key of the trusted party. Using two of encryption provides additional security even in cases where the key fragments are stored at devices operated by each escrow party rather than the server computer 101.

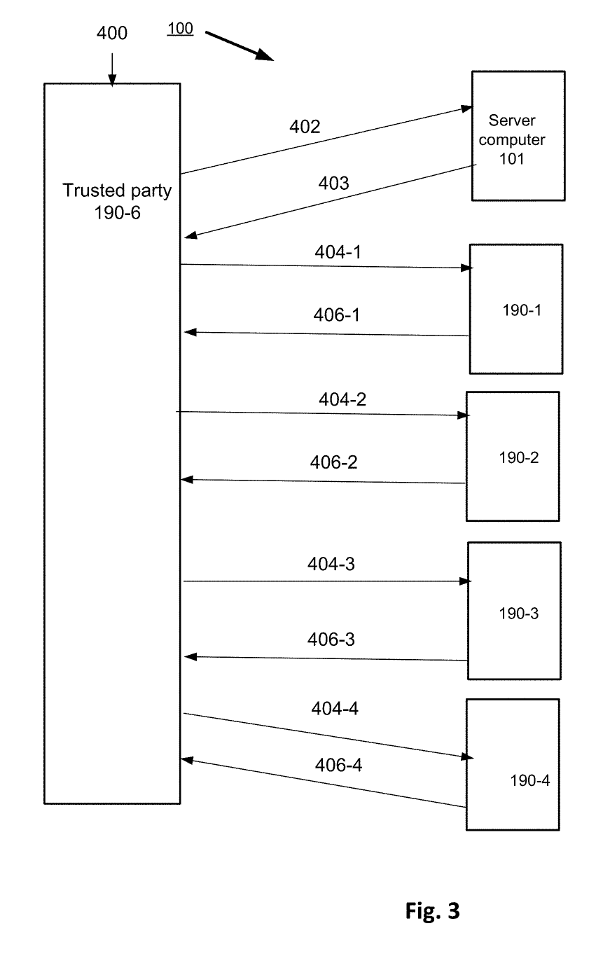

FIG. 3 shows operation of the system 100 for reassembling the fragmented keys to obtain the key K. The network 120 and the connections 121, 123-1, 123-2, 123-3, 123-4, 123-5 and 123-6 are omitted from FIG. 3 for ease of reference. The device 190-6 operated by the trusted party receives instructions that the key is to be reassembled as shown by an arrow 400. Such instructions may for example be received when a court order has been received from a third party such as a government agency. Operations performed by the device 190-6 are implemented by execution of the application 163 on the processor 165.

The trusted party device 190-6 makes a transmission to the server computer 101, as indicated by an arrow 402-1. In the transmission 402, the device 190-6 requests all key fragments and the encrypted data D. The server computer 101 responds by sending a transmission indicated by an arrow 403-1. The transmission 403 includes all the relevant encrypted key fragments [[Kfᵢ]Pubᵢ]Pubₜ and the encrypted data D.

The application 163 executes of the processor 165 of the trusted party device 190-6 to decrypt each key fragment [[Kfᵢ]Pubᵢ]Pubₜ using the trusted party private key Privₜ. Such results in generation of each key fragment as encrypted by the relevant escrow party, [Kfᵢ]Pubᵢ.

The trusted party device 190-6 makes a transmission to each of the escrow devices 190-1 to 190-4, as indicated by arrows 404-1 to 404-4. Each of the transmissions 404-1 to 404-4 includes a corresponding encrypted key fragment [Kfᵢ]Pubᵢ for each escrow party, and a request for decryption.

Each of the devices 190-1 to 190-4 receives the corresponding encrypted fragment and request. Each consenting escrow party i decrypts the corresponding key portion using the relevant private key (Privᵢ). The decrypted fragments Kfᵢ are each returned to the trusted party 190-6, as shown by arrows 406-1 to 406-4. Providing the decrypted fragment in some instances is sufficient to indicate consent from each escrow party. All escrow parties must provide consent in order for the key to be reassembled.

The application 163 of the trusted party device 190-6 receives the decrypted fragments 406-1 and 406-4 and reassembles the key K. The key K can then be applied to the encrypted object D to obtain the unencrypted data d.

The key fragments in the transmissions 406-1 to 406-4 of FIGS. 4 are provided in the clear. However, given that each transmission relates only to a portion of the key, and that secure standards such as TLS or SSL are used in communications, security of the key fragments, and thus the key K, can be maintained.

### INDUSTRIAL APPLICABILITY

The arrangements described are applicable to the computer and data processing industries and particularly for the data encryption industries. The arrangements described provide an effect by which data management relating to fragmented keys may be simplified, and accordingly jurisdictional privacy requirements satisfied, without compromising security of information.

The foregoing describes only some embodiments of the present invention, and modifications and/or changes can be made thereto without departing from the scope and spirit of the invention, the embodiments being illustrative and not restrictive.

1. A method of managing access to a key comprising:
associating the key with an encrypted data object, the key being required to decrypt the data object;
generating a number of fragments of the key, with the number of fragments corresponding to a number of parties subject to a fragmentation agreement;
encrypting each fragment with a public key corresponding to each of the parties;
encrypting each encrypted fragment with a public key of a trusted party; and
storing the encrypted fragments with the encrypted data object on a server of the trusted party.

2. The method according to claim 1, further comprising:
the server receiving an instruction to reassemble the fragmented key;
the server identifying the number of encrypted fragments of the key, the number of encrypted fragments corresponding to the number of parties;
the server transmitting each identified encrypted fragment to a trusted party, the fragments being decrypted with the corresponding private key;
the trusted party transmitting each encrypted fragment to a corresponding one of the parties, each party decrypting the corresponding encrypted fragment with a corresponding private key associated with the party, and sending the decrypted fragments to the trusted party;
the trusted party receiving the decrypted fragments; and
reassembling the key using the decrypted fragments.
